(19) United States
(12) Patent Application Publication
(10) Pub. No.: US 2011/0039598 A1
(43) Pub. Date: Feb. 17, 2011

(54) METHODS AND DEVICES FOR ADDING SOUND ANNOTATION TO PICTURE AND FOR HIGHLIGHTING ON PHOTOS AND MOBILE TERMINAL INCLUDING THE DEVICES

(75) Inventors: Jian TANG, Beijing (CN); Thomas SNYDER, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/721,985

(22) Filed: Mar. 11, 2010

(30) Foreign Application Priority Data
Aug. 13, 2009 (CN) 200910163335.4

(51) Int. Cl. H04N 5/76; H04W 88/02

(52) U.S. Cl. 455/556.1; 348/231.4

(57) ABSTRACT

A method and device for adding sound annotations to a picture, and a mobile terminal including the device are disclosed. The method adds sound annotations to a picture in the mobile terminal, comprising: selecting and displaying a picture on a display device of the mobile terminal; selecting an arbitrary position on the picture; starting a sound recording function to record sound annotations for said arbitrary position on the picture; and saving the picture and the recorded sound annotations. With the present disclosure, a user of the mobile terminal can conveniently add sound annotations to a photo when the photo is taken with a camera included in the mobile terminal, so as to record wonderful “sound and picture” contents, or edit and send multimedia messages having “sound hyperlinks”. A method and device for adding a visual mark onto a picture, and a mobile terminal including the device are also disclosed.

### CROSS-REFERENCE TO RELATED APPLICATION

This application claims priority to Chinese Patent Application No. 200910163335.4, filed on Aug. 13, 2009, which is incorporated herein by reference in its entirety.

### FIELD OF THE DISCLOSURE

The present disclosure relates to technologies for adding sound annotations to a picture and for highlighting on the picture in a mobile terminal, and more particularly, to methods and devices for adding sound annotations to a picture and for highlighting on the picture in a mobile terminal, and a mobile terminal including the devices.

### BACKGROUND OF THE DISCLOSURE

Current mobile terminals, such as mobile phones, generally have the functions of photographing and video recording.

The common photographing cannot record sound information. The video recording can record both image and sound information, but the image quality is not as good as that achieved by static photographing, and a large storage capacity is required to save the image and sound information.

For example, during a tour, people usually take photos with their mobile phones with themselves, and after the tour, they will sort the photos and compile travel notes with both pictures and literary compositions. However, a problem may occur that it may be hard for the photographers themselves to remember locations where many photos are taken and some special matters during the photographing. Of course, the photos can also be sorted in time during the tour, and remarked with literal descriptions, but this is troublesome for persons of strong travel interest.

In addition, when you sometimes want to express greetings or blessings to your friends by sending multimedia messages through the mobile phone, it will be more gracious to send your photo added with your voice. However, the current mobile terminal still cannot conveniently achieve this function.

### SUMMARY OF THE DISCLOSURE

In view of the above problems in the prior art, the present disclosure is presented to provide a method and device for adding sound annotations to a picture in a mobile terminal, a method and device for adding a visual mark onto a picture photographed with a camera included in a mobile terminal, and the mobile terminal including the devices. With the present disclosure, a user of the mobile terminal can conveniently add sound annotations or a visual mark to a photo when the photo is taken with a camera included in the mobile terminal, so as to record wonderful “sound and picture” contents (e.g., travel notes), or add sound annotations to other pictures stored in the mobile terminal, or edit and send multimedia messages having “sound hyperlinks”.

A first aspect of the present disclosure provides a method for adding sound annotations to a picture in a mobile terminal, comprising: selecting and displaying a picture on a display device of the mobile terminal; selecting an arbitrary position on the picture; starting a sound recording function to record sound annotations for said arbitrary position on the picture; and saving the picture and the recorded sound annotations.

Preferably, the process of saving the picture and the recorded sound annotations comprises saving the picture, the position on the picture where the sound annotations are added, and the corresponding sound annotations in association with each other.

Preferably, the picture and the recorded sound annotations may be saved in a single multi-media file.

Preferably, the display device of the mobile terminal may have a touch screen, with which a user may operate on the displayed picture.

Preferably, the mobile terminal may comprise a sound annotation activating key, and a process of adding sound annotations to the picture may be activated by pressing the sound annotation activating key.

Preferably, once a photo is taken with a camera device of the mobile terminal, a sound annotation addition function built in the mobile terminal may be immediately activated, so as to start a process of adding sound annotations to the taken photo.

Preferably, once the sound annotations are added to a position on the picture, a sound icon may be generated at the position. Thus, when a user views the picture, the corresponding sound annotations may be played back by clicking the sound icon or staying the cursor at the sound icon.

Preferably, the sound icon may be hidden after being generated, so as to prevent the sound icon from shielding the picture contents. In this case, when a user views the picture, the user may instruct to display the sound icon again, so that the user will know which positions are added with the sound annotations.

A second aspect of the present disclosure provides a device for adding sound annotations to a picture included in a mobile terminal, comprising: a sound annotation activating functional portion adapted to activate a process of adding sound annotations to a picture; a picture selecting portion adapted to select a picture, so as to display the picture on a display device of the mobile terminal; a sound annotation recording portion adapted to select a position on the picture displayed on the display device of the mobile terminal, and enable a sound recording device of the mobile terminal to record sound annotations for the position; and a saving portion adapted to save the picture and recorded sound annotations.

Preferably, the saving portion may be adapted to save the picture, the position on the picture where the sound annotations are added, and the corresponding sound annotations in association with each other.

Preferably, the saving portion may be adapted to save the picture and the recorded sound annotations in a single multi-media file.

Preferably, the display device of the mobile terminal may have a touch screen, and the picture selecting portion may be activated by touching the touch screen.

Preferably, the sound annotation activating functional function may be configured as an separate operating button.

Preferably, the sound annotation activating functional function may be adapted to couple with a camera device of the mobile terminal, so that once a photo is taken with the camera device, the device for adding sound annotations to a picture may be immediately activated to add sound annotations to the taken photos.

Preferably, the sound annotation recording portion may be adapted to generate, after sound annotations are added to a position on the picture, a sound icon at the position. Thus, when a user views the picture, the corresponding sound annotations may be played back by clicking the sound icon or staying the cursor at the sound icon.

Preferably, the sound annotation recording portion may be adapted to be capable of hiding the sound icon. Thus, when a user views the picture, the user may instruct to display the sound icon again, to know which positions are added with the sound annotations.

A third aspect of the present disclosure provides a mobile terminal, comprising the device for adding sound annotations to a picture as described previously.

A fourth aspect of the present disclosure provides a program product comprising program instructions, which, when being loaded onto a mobile terminal, enables the mobile terminal to: select and display a picture on a display device of the mobile terminal; select an arbitrary position on the picture; start a sound recording function to record sound annotations for the arbitrary position on the picture; and save the picture and the recorded sound annotations.

A fifth aspect of the present disclosure provides a recording medium containing therein program instructions, which, when being loaded onto a mobile terminal, enables the mobile terminal to: select and display a picture on a display device of the mobile terminal; select an arbitrary position on the picture; start a sound recording function to record sound annotations for the arbitrary position on the picture; and save the picture and the recorded sound annotations.

A sixth aspect of the present disclosure provides a logic for use in a mobile terminal for adding sound annotations to a picture, comprising: logic for selecting and displaying a picture on a display device of the mobile terminal; logic for selecting an arbitrary position on the picture; logic for starting a sound recording function to record sound annotations for the arbitrary position on the picture; and logic for saving the picture and the recorded sound annotations.

The fourth to sixth aspects may further be modified in reference to the above preferred modes.

A seventh aspect of the present disclosure provides a method for adding a visual mark onto a picture photographed with a camera included in a mobile terminal, comprising: in response to a picture having been photographed with the camera, prompting a user of the mobile terminal to add a visual mark onto the picture; selecting, by the user, a position on the picture and drawing a mark at the position; and saving the picture and the mark in association with each other.

Preferably, the process of prompting is triggered automatically by the completion of the photographing operation.

Preferably, the process of prompting is triggered by the user pressing a specific button provided on the mobile terminal.

Preferably, the mobile terminal comprise a touch screen, and the process of selecting, by the user, a position on the picture and drawing a mark at the position is performed by touching the touch screen with a finger or a stylus.

Preferably, the method further comprises: typing or speaking a text or audio annotation into the mobile terminal to pair with the mark; and saving the text or audio annotation in association with the picture containing the mark.

Preferably, the picture and the text or audio annotation are saved in a single multi-media file.

An eighth aspect of the present disclosure provides a device for adding a visual mark onto a picture photographed with a camera included in a mobile terminal, comprising: a prompting portion, adapted to, in response to a picture having been photographed with the camera, prompt a user of the mobile terminal to add a visual mark onto the picture; a drawing portion, adapted to select, by the user, a position on the picture and draw a mark at the position; and a saving portion, adapted to save the picture and the mark in association with each other.

Preferably, the prompting portion is coupled with the camera so as to be triggered automatically by the completion of the picture being photographed with the camera.

Preferably, the prompting portion is provided as a specific button on the mobile terminal.

Preferably, the mobile terminal comprise a touch screen, and the drawing portion is coupled with the touch screen so as to select, by the user, a position on the picture and draw a mark at the position by touching the touch screen with a finger or a stylus.

Preferably, the device further comprises: an annotation adding portion, adapted to add a text or audio annotation pairing with the mark that is typed or spoken into the mobile terminal, and wherein the text or audio annotation is saved in association with the picture containing the mark.

Preferably, the picture and the text or audio annotation are saved in a single multi-media file.

A ninth aspect of the present disclosure provides a mobile terminal, comprising the device for adding a visual mark as described previously.

A tenth aspect of the present disclosure provides a program product comprising program instructions, which, when being loaded onto a mobile terminal, enables the mobile terminal to: in response to a picture being photographed with the camera, prompt a user of the mobile terminal to add a visual mark onto the picture; select, by the user, a position on the picture and drawing a mark at the position; and save the picture and the mark in association with each other.

An eleventh aspect of the present disclosure provides a recording medium containing therein program instructions, which, when being loaded onto a mobile terminal, enables the mobile terminal to: in response to a picture being photographed with the camera, prompt a user of the mobile terminal to add a visual mark onto the picture; select, by the user, a position on the picture and drawing a mark at the position; and save the picture and the mark in association with each other.

A twelfth aspect of the present disclosure provides a logic for use in a mobile terminal for adding a visual mark onto a picture being photographed with a camera included in the mobile terminal, comprising: logic for in response to a picture being photographed with the camera, prompting a user of the mobile terminal to add a visual mark onto the picture; logic for selecting, by the user, a position on the picture and drawing a mark at the position; and logic for saving the picture and the mark in association with each other.

The tenth to twelfth aspects may further be modified in reference to the above preferred modes.

These and further aspects of the present disclosure will be apparent with reference to the following description and drawings. In the description and drawings, particular embodiments of the present disclosure have been disclosed in details as being indicative of some of the ways in which the principles of the present disclosure may be employed, but it shall be understood that the present disclosure is not limited correspondingly in scope. Rather, the disclosure comprises all changes, modifications and equivalents falling within the spirit and scope of the accompanied claims.

Features that are described and/or illustrated with respect to one embodiment may be used in the same way or in a similar way in one or more other embodiments and/or in combination with or instead of the features of the other embodiments.

It shall be emphasized that the term “comprise/include” or “comprising/including” as used in this specification is taken to specify the presence of stated features, integers, steps or components, but does not preclude the presence or addition of one or more other features, integers, steps, components or groups thereof.

Many aspects of the present disclosure can be better understood with reference to the following drawings. The components in the drawings are not necessarily to scale, emphasis instead being placed upon clearly illustrating the principles of the present disclosure. To facilitate illustrating and describing some parts of the present disclosure, corresponding portions of the drawings may be exaggerated in size, e.g., made larger in relation to other parts than in an exemplary device actually made according to the disclosure. Elements and features depicted in one drawing or embodiment of the disclosure may be combined with elements and features depicted in one or more additional drawings or embodiments. Moreover, in the drawings, same reference numerals designate corresponding parts throughout the drawings and may be used to designate like or similar parts in more than one embodiment.

### BRIEF DESCRIPTION OF THE DRAWINGS

The drawings, which are included as a part of the specification, are used for illustrating the embodiments of the present disclosure, and to explain the principle of the present disclosure together with the description, in which:

FIG. 1 is a functional block diagram illustrating a configuration of a mobile phone according to an embodiment of the present disclosure;

FIG. 2 is a functional block diagram illustrating a configuration of a device for adding sound annotations included in the mobile phone according to the embodiment of the present disclosure;

FIG. 3 is a flow diagram illustrating a method for adding sound annotations to a picture using the mobile phone according to the embodiment of the present disclosure;

FIG. 4 illustrates a picture added with sound annotations and having sound annotation links according to the embodiment of the present disclosure;

FIG. 5 is a block diagram illustrating an operating circuit or system configuration of the mobile phone according to the embodiment of the present disclosure;

FIG. 6 is a functional block diagram illustrating a configuration of a mobile phone according to another embodiment of the present disclosure;

FIGS. 7A and 7B illustrate two pictures before and after adding a visual mark, respectively;

FIG. 8 is a functional block diagram illustrating a configuration of a visual mark adding device included in the mobile phone according to the embodiment of the present disclosure; and

FIG. 9 is a flow diagram illustrating a method for adding a visual mark to a picture using the mobile phone according to the embodiment of the present disclosure.

### DETAILED DESCRIPTION OF THE EMBODIMENTS

The interchangeable terms “electronic apparatus” and “electronic device” include portable radio communication apparatus. The term “portable radio communication apparatus”, which hereinafter is referred to as a “mobile terminal”, “portable electronic device”, or “portable communication device”, comprises all apparatuses such as mobile telephones, pagers, communicators, electronic organizers, personal digital assistants (PDAs), smartphones, portable communication devices or the like.

In the present application, embodiments of the disclosure are described primarily in the context of a portable electronic device in the form of a mobile telephone (also referred to as “mobile phone”). However, it shall be appreciated that the disclosure is not limited to the context of a mobile telephone and may relate to any type of appropriate electronic apparatus having the functions of photographing and sound recording.

The preferred embodiments of the present disclosure are described as follows in reference to the drawings.

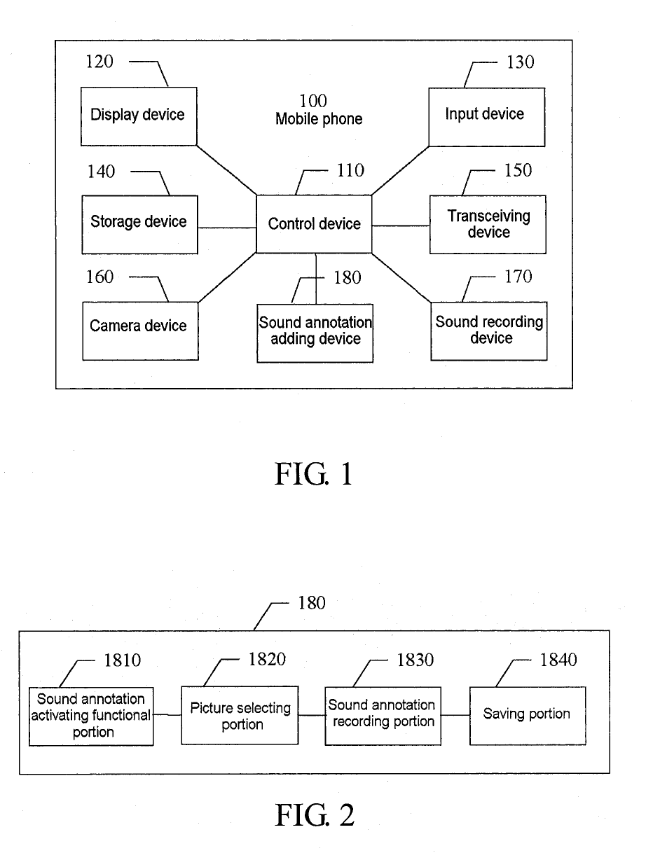

FIG. 1 is a functional block diagram illustrating a configuration of a mobile phone according to an embodiment of the present disclosure.

As shown in FIG. 1, a mobile phone 100 may comprise a control device 110, a display device 120, an input device 130, a storage device 140, a transceiving device 150, a camera device 160, a sound recording device 170 and a sound annotation adding device 180.

The control device 110 may be adapted to control overall operations of respective components of the mobile phone 100, and for example, may include a processor exclusively used for mobile phone.

The display device 120 may be adapted to display text or image information, and for example, may include a liquid crystal screen or a LED screen.

The input device 130 may be adapted to input a command or character, for example, including number keys, letter keys, special function keys, a navigation key, etc. The input device 130 may also be a touch panel, and in this case, it may be preferable to couple the touch panel with the display device 120 to form a touch screen.

The storage device 140 is adapted to store information of multi-media contents, such as text, picture, sound and video, and for example, may be include a removable memory card.

The transceiving device 150 may include a radio transceiving module for receiving radio information from a radio network and converting the received radio information to information adaptable to be locally processed, or converting information to be transmitted to radio information and transmitting the converted ration information to the radio network, when the mobile phone 100 accesses the radio network. In addition, the transceiving device 150 may also include near-field transceiving modules such as an infrared transceiving module and a Bluetooth transceiving module.

The camera device 160 is adapted to take a static image or a continuous video.

The sound recording device 170 is adapted to record sounds, such as voices of a user of the mobile phone, or any other sound else. The sound recording device 170 may include a microphone, for example.

The above described control device 110, display device 120, input device 130, storage device 140, transceiving device 150, camera device 160 and sound recording device 170 are all conventional configurations of the mobile phone, and their detailed configurations may be apparent from the prior art, and herein are not described.

The present disclosure differs from the mobile phone of the prior art in that the sound annotation adding device 180 is provided in the mobile phone 100.

For example, during the tour, a user may take photos with the camera device 160 of the mobile phone 100. After the tour, the user may move the taken photos from the mobile phone 100 to a computer for further edition and sorting. If there are too many photos or the work is started after a long time, the user often cannot clearly remember the photographing condition or the feeling at that time. But with this disclosure, the mobile phone 100 is provided with the sound annotation adding device 180, thus the user can add sound annotations to the photos in time to explain photographing sites, photographing parameters, scenes, weather, moods, etc, and this brings convenience for further photo edition and sorting in the future.

The function and configuration of the sound annotation adding device 180 are described as follows with reference to FIG. 2.

As shown in FIG. 2, the sound annotation adding device 180 may include a sound annotation activating functional portion 1810, a picture selecting portion 1820, a sound annotation recording portion 1830 and a saving portion 1840.

The sound annotation activating functional portion 1810 may be adapted to activate a process of adding sound annotations to a picture. The sound annotation activating functional portion 1810 may be configured as a separate operating button, for example, and the process of adding sound annotations to a picture can be activated by pressing the operating button; or the sound annotation activating functional portion 1810 may be a menu displayed on the display device 120, and the process of adding sound annotations to a picture may be activated by clicking the menu.

The picture selecting portion 1820 may be adapted to select a picture, so as to display the picture on the display device 120 of the mobile terminal 100. With the sound annotation activating functional portion 1810 being operated by the user, the function of the picture selecting portion 1820 is activated to select a picture to be added with sound annotations. Alternatively, the sound annotation activating functional portion 1810 and the camera device 160 may be coupled with each other, so as to trigger the function of the picture selecting portion 1820 just through the completion of a photographing action of the camera device 160, and the currently taken photo is the picture selected by the picture selecting portion 1820.

The sound annotation recording portion 1830 may be adapted to select a position on the picture displayed on the display device 120 of the mobile terminal 100, enable the sound recording device 170 to record sound annotations for the position, and selectively add a sound icon at the position. The completion of the picture selection by the picture selecting portion 1820 triggers the function of the sound annotation recording portion 1830. At that time, for example, a navigation key of the mobile phone 100 may be used to control the movement of the cursor on the picture, and when the cursor reaches the desired position and the position is clicked, the sound recording device 170 is enabled to record the user's descriptive speech for the position. Alternatively, if the display device 120 is a touch screen, the position selection can be easily carried out via the operation of a stylus or finger on the touch screen.

Alternatively, the sound annotation recording portion 1830 may be further adapted to hide the added sound icon so as not to influence the picture appearance. When the picture added with sound annotations is viewed by means of the mobile phone 100, the user may instruct to display the sound icon again, so that the user will know which positions are added with the sound annotations, and then operate at the positions to play back the sound annotations therein.

Alternatively, the sound annotation recording portion 1830 may be further adapted not to add a sound icon at a corresponding position, when sound annotations are added. When the picture added with sound annotations is viewed by means of the mobile phone 100, the sound annotations added at a position will be automatically played back once the cursor stays at or passes by the position. For example, when the display device 120 is composed of a touch screen, the user can listen to the sound annotations at respective positions by moving the stylus or his finger on the screen, and this is very convenient to the user.

The saving portion 1840 may be adapted to save a picture and recorded sound annotations as a single multi-media file in the storage device 140, or separately save the picture and the recorded sound annotations in the storage device 140. When storing the picture and the recorded sound annotations, the saving portion 1840 associates the coordinates of the positions added with sound annotations in the picture with the sound annotations added at the respective positions, and in the case of separately saving the picture and the recorded sound annotations, associates the coordinates of the positions added with sound annotations in the picture with the storage locations of the sound annotations added at the respective positions, and records the association relations together with the picture and the sounds at a proper location in the storage device 140. Thus, when the user clicks each sound icon/position or stays the cursor at the sound icon/position, the mobile phone 100 plays back the sound annotations at the corresponding position.

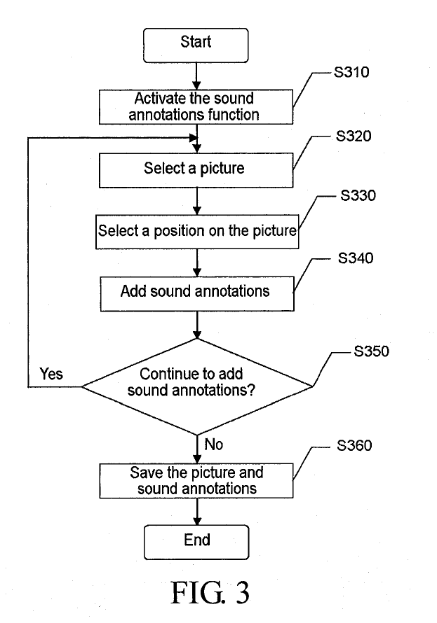

A method for adding sound annotations to a picture using the mobile phone 100 according to the embodiment of the present disclosure is described as follows with reference to the flow diagram of FIG. 3.

For example, after taking photos with the camera device 160 of the mobile phone 100, the user can add appropriate sound annotations to the photos in the following process by using the sound annotation adding device 180. It can be easily appreciated that the present disclosure is not limited to only add sound annotations to the photos taken by the camera device 160, it also can add sound annotations to images stored in the storage device 140 of the mobile phone 100. The processes of adding sound annotations for the two cases are similar to each other.

Firstly, in step S310, the user activates a process of adding sound annotations to a picture, for example, by means of a sound annotation function activating button separately provided, or by clicking a sound annotation addition menu displayed on the display device 120. Alternatively, the process of adding sound annotations to a picture may also be activated by the completion of a photographing action. This is corresponding to the function of the sound annotation activating functional portion 1810 in the sound annotation adding device 180.

Next, in step S320, the user selects a picture to be added with sound annotations from the pictures stored in the storage device 140 by operating the input device 130, and then the picture is displayed on the display device 120. Alternatively, when the process of adding sound annotations to a picture is activated by the completion of a photographing action, the selection is not performed, and the currently taken photo may directly taken as the picture to be added with sound annotations. This is corresponding to the function of the picture selecting portion 1820 of the sound annotation adding device 180.

Next, in step S330, the user selects a position on the picture displayed on the display device 120, and then in step S340, the sound recording device 170 is enabled to record sound annotations for the position, e.g., descriptions of photographing sites, photographing parameters, scenes, weather, moods, etc., and meanwhile, a sound icon may be selectively added at the position. For example, the navigation key of the mobile phone 100 may be used to control the movement of the cursor on the picture, and when the cursor reaches the desired position, the sound recording device 170 is enabled, by clicking the position, to record the user's descriptive speech for the position. Alternatively, if the display device 120 is a touch screen, the selection of the position may be easily carried out via the operation of a stylus or finger on the touch screen.

Alternatively, after the sound annotations are added, the added sound icon may be hidden so as not to influence the picture appearance. Thus, when the picture added with sound annotations is viewed by means of the mobile phone 100, the user may instruct to display the sound icon again, so that the user will know which positions are added with the sound annotations, and then listen to the sound annotations by operating at the corresponding positions.

Alternatively, during the addition of sound annotations, a sound icon may be not added at a corresponding position. In this case, when the picture added with sound annotations is viewed by means of the mobile phone 100, the sound annotations at the respective positions will be automatically played back once the cursor stays at or passes by the positions. For example, when the display device 120 is composed of a touch screen, the user can listen to the sound annotations at respective positions by moving the stylus or his finger on the screen, and this is very convenient.

After adding the sound annotations to the selected position, in step S350, it is determined whether to continue to add sound annotations to the picture.

If the determination result in step S350 is “Yes”, then the procedure returns to step S330 and operates as mentioned previously, selects another position in the picture, and adds sound annotations to the position.

If the determination result in step S350 is “No”, then the procedure goes to step S360, and in this step, the picture and the recorded sound annotations are saved as a single multi-media file in the storage device 140. Alternatively, the picture and the recorded sound annotations can also be separately saved in the storage device 140. When the picture and the recorded sound annotations are saved, the coordinates of the positions added with sound annotations in the picture are associated with the sound annotations added at the respective positions, and in the case of separately saving the picture and the recorded sound annotations, the coordinates of the positions added with sound annotations in the picture are associated with the storage location of the sound annotations added at the respective positions, and the association relations, together with the picture and the sounds, are recorded at an appropriate location in the storage device 140. Thus, when the user clicks each sound icon/position or stays the cursor at the sound icon/position, the mobile phone 100 plays back the sound annotations at the corresponding position.

Step 330 to the “Yes” branch in step S350 is corresponding to the function of the sound annotation recording portion 1830 of the sound annotation adding device 180.

Step 360 is corresponding to the function of the saving portion 1840 of the sound annotation adding device 180.

In the above step S350, for example, a prompt message about whether to continue to add sound annotations is displayed on the display device 110 by means of the sound annotation adding device 180, and the determination process is completed with a selection operation to be performed by the user. For example, a “Continue” button and an “Exit” button may be displayed on the display device 110, if the user clicks the “Continue” button, the procedure goes to step S320, while if the user clicks the “Exit” button, the procedure goes to step S360.

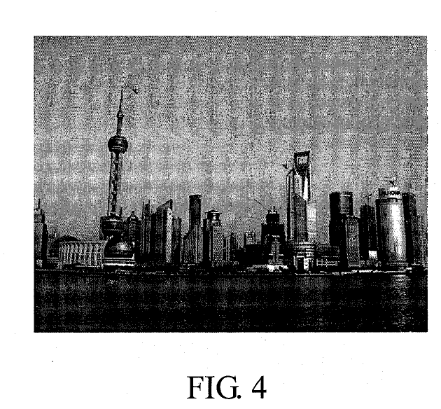

FIG. 4 illustrates a picture added with sound annotations and having sound icons (small horns) according to the above procedure. Thus, when viewing the picture with the mobile phone 100, the user may hear the added sound annotations just by clicking the respective sound icons on the picture, so as to facilitate subsequent operations.

Of course, as mentioned previously, after the sound annotations are added, the sound icons may be hidden, and during the subsequent picture browsing, the user may instruct to display the sound icons again. Of course, as mentioned above, the sound icons may be not added at all.

With the present disclosure, the user of the mobile phone can conveniently add sound annotations to a photo taken with the camera included in the mobile phone, so as to record wonderful “sound and picture” contents (e.g., travel notes), or edit and send multimedia messages having “sound hyperlinks”.

For example, with a mobile phone enabling touch screen input, the user can take photos with the mobile phone, and then click any expected position on the touch screen to record sound annotations for the position. The contents of the sound annotation, for example, may include:

1) Voices of each person in a group picture, such as birthday blessing of each person in a birthday party;

2) explanation and comment on each building in the wide-angle photos; or

3) explanation of any interesting place in the scene, etc.

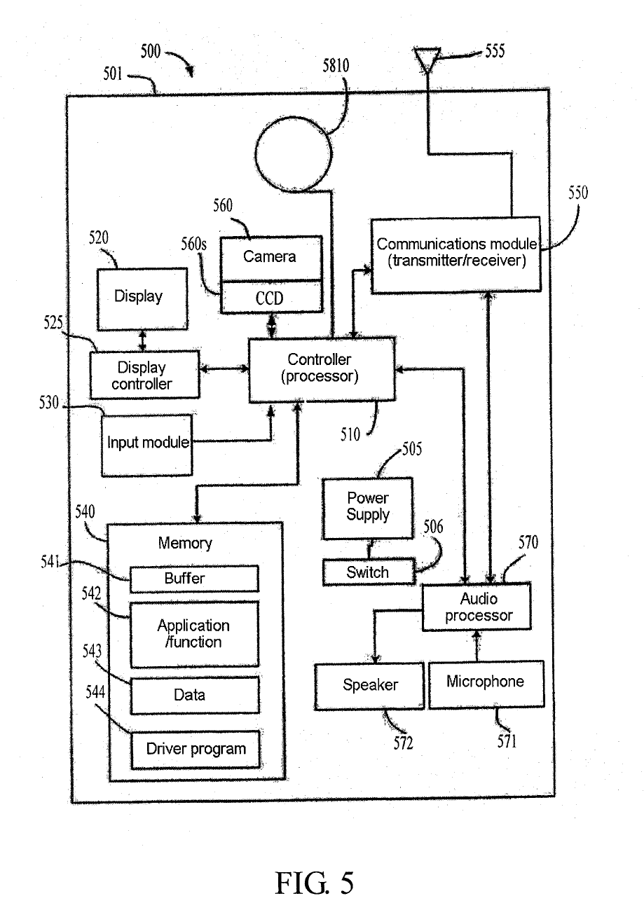

A block diagram illustrating the operating circuit or system configuration of the mobile phone having the function of adding sound annotations to a picture in the present disclosure is described as follows with reference to FIG. 5.

FIG. 5 illustrates a schematic block diagram of an operating circuit 501 or system configuration of a mobile phone 500 according to an embodiment of the present disclosure. The illustration is exemplary; other types of circuits may be employed in addition to or instead of the operating circuit to carry out telecommunication functions and other functions. The operating circuit 501 comprises a controller 510 (sometimes referred to as a processor or an operational control and may include a microprocessor or other processor device and/or logic device) that receives inputs and controls the various parts and operations of the operating circuit 501. An input module 530 provides inputs to the controller 510. The input module 530 for example is a key or touch input device. A camera 560 may include a lens, shutter, image sensor 560s (e.g., a digital image sensor such as a charge coupled device (CCD), a CMOS device, or another image sensor). Images sensed by the image sensor 560s may be provided to the controller 510 for use in conventional ways, e.g., for storage, for transmission, etc.

A display controller 525 responds to inputs from a touch screen display 520 or from another type of display 520 that is capable of providing inputs to the display controller 525. Thus, for example, touching of a stylus or a finger to a part of the touch screen display 520, e.g., to select a picture in a displayed list of pictures, to select an icon or function in a GUI shown on the display 520 may provide an input to the controller 510 in conventional manner. The display controller 525 also may receive inputs from the controller 510 to cause images, icons, information, etc., to be shown on the display 520. The input module 530, for example, may be the keys themselves and/or may be a signal adjusting circuit, a decoding circuit or other appropriate circuits to provide to the controller 510 information indicating the operating of one or more keys in conventional manner.

A memory 540 is coupled to the controller 510. The memory 540 may be a solid state memory, e.g., read only memory (ROM), random access memory (RAM), SIM card, etc., or a memory that maintains information even when power is off and that can be selectively erased and provided with more data, an example of which sometimes is referred to as an EPROM or the like. The memory 540 may be some other type device. The memory 540 comprises a buffer memory 541 (sometimes referred to herein as buffer). The memory 540 may include an applications/functions storing section 542 to store applications programs and functions programs or routines for carrying out operation of the mobile phone 500 via the controller 510. The memory 540 also may include a data storage section 543 to store data, e.g., contacts, numerical data, pictures, sounds, and/or any other data for use by the mobile phone 500. A driver program storage section 544 of the memory 540 may include various driver programs for the mobile phone 500, for communication functions and/or for carrying out other functions of the mobile phone 500.

The mobile phone 500 comprises a telecommunications portion. The telecommunications portion comprises, for example, a communications module 550, i.e., transmitter/receiver 550 that transmits outgoing signals and receives incoming signals via antenna 555. The communications module (transmitter/receiver) 550 is coupled to the controller 510 to provide input signals and receive output signals, as may be same as the case in conventional mobile phones. The communications module (transmitter/receiver) 550 also is coupled to a speaker 572 and a microphone 571 via an audio processor 570 to provide audio output via the speaker 572 and to receive audio input from the microphone 571 for usual telecommunications functions. The speaker 572 and microphone 571 enable a user to listen and speak via the mobile phone 500. The audio processor 570 may include any appropriate buffer, decoder, amplifier and the like. In addition, the audio processor 570 is also coupled to the controller 510, so as to locally record sounds via the microphone 571, e.g., add sound annotations to a picture, and sounds locally stored, e.g., the sound annotations to the picture, can be played via the speaker 572.

The mobile phone 500 also comprises a power supply 505 that may be coupled to provide electricity to the operating circuit 501 upon closing of an on/off switch 506.

For telecommunication functions and/or for various other applications and/or functions as may be selected from a GUI, the mobile phone 500 may operate in a conventional way. For example, the mobile phone 500 may be used to make and to receive telephone calls, to play songs, pictures, videos, movies, etc., to take and to store photos or videos, to prepare, save, maintain, and display files and databases (such as contacts or other database), to browse the Internet, to remind a calendar, etc.

After taking photos with the camera 560, the user can choose to directly activate the sound annotation addition function built in the mobile phone 500 to add sound annotations to the picture. Alternatively, a separate sound annotation activating button 5810 is provided on the mobile phone 500. When the sound annotation activating button 5810 is pressed by the user, the function of adding sound annotations to a picture will be activated, so that the user can select a picture from pictures stored in the memory 540 of the mobile phone 500, add appropriate sound annotations to the selected picture, and save them. The detailed process of adding sound annotations has been described previously, and herein is not described. Other constructional modules for the sound annotation addition function built in the mobile phone 500 also have been described previously, and herein are not repeated.

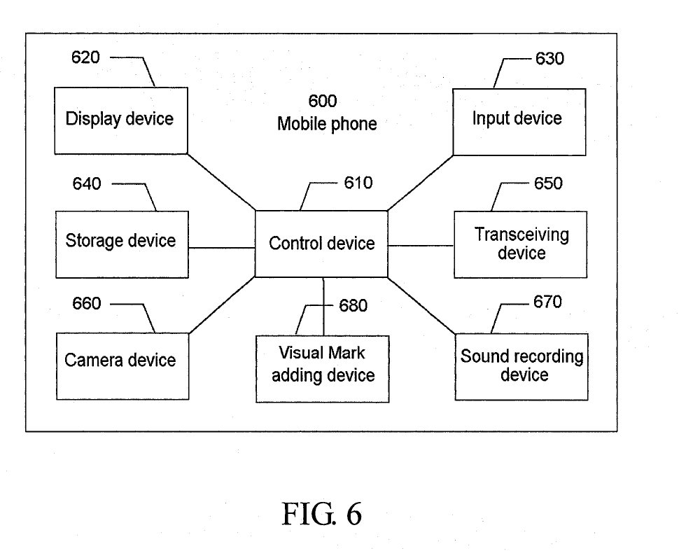

FIG. 6 is a functional block diagram illustrating a configuration of a mobile phone with a visual mark adding function according to another embodiment of the present disclosure.

As shown in FIG. 6, the mobile phone 600 may comprise a control device 610, a display device 620, an input device 630, a storage device 640, a transceiving device 650, a camera device 660, a sound recording device 670 and a visual mark adding device 680.

The control device 610, the display device 620, the input device 630, the storage device 640, the transceiving device 650, the camera device 660 and the sound recording 670 are the same as the corresponding ones included in the mobile phone 100 illustrated in FIG. 1, and thus are not further described in detail.

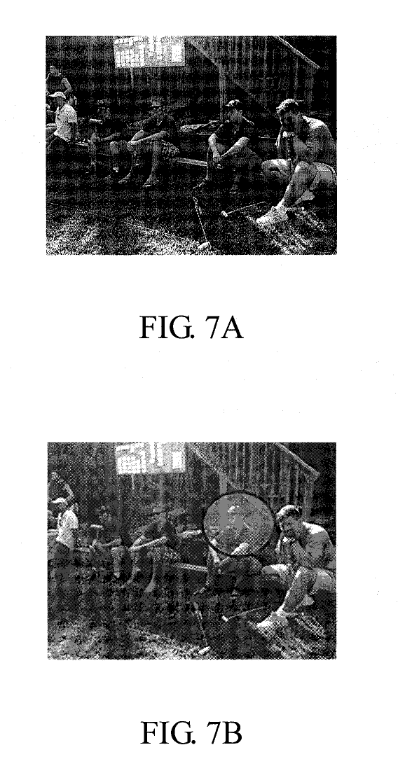

According to the embodiment of the present disclosure, the mobile phone 600 is provided with the visual mark adding device 680. Thus, once a picture is taken, the user of the mobile phone 600 can select a position on the picture so as to add a visual mark such as a highlight dot, outline border or semi-transparent local highlight onto the picture at that position. Then, the visual mark may be paired with a text annotation that is typed into the mobile phone 600 via a keypad included in the input device 630, for example. The text annotation may then be stored in association with the picture and the visual mark. Alternatively, if the mobile phone 600 further includes a sound annotation adding device as illustrated in FIG. 1, the visual mark may be paired with a sound annotation that is spoken into the mobile phone 600 via the sound recording device 670, for example. The sound annotation may also be stored with the picture and the visual mark. In this case, in response to take a group picture as shown in FIG. 7A, for example, the user can select “Brian” in the picture, draw a visual mark such as a semi-transparent ellipse with a black border as shown in FIG. 7B and speak “this is Brian, he came from Virginia to compete in the croquet tournament but didn't make the final” into the mobile phone 600. Later when the picture is viewed, a viewer can pick out Brian from the picture even if he/she did not know who he was before.

As mentioned previously, the display device 670 may include a touch screen. In this case, a visual mark may be easily drawn onto a picture by the user of the mobile phone 600 on the touch screen with one of his/her fingers or a stylus once the picture is taken. Alternatively, a visual mark may be added by the user of the mobile phone 600 moving the cursor on the screen of the display device 670 with a specific button such as a navigation button if the display device 670 does not include a touch screen.

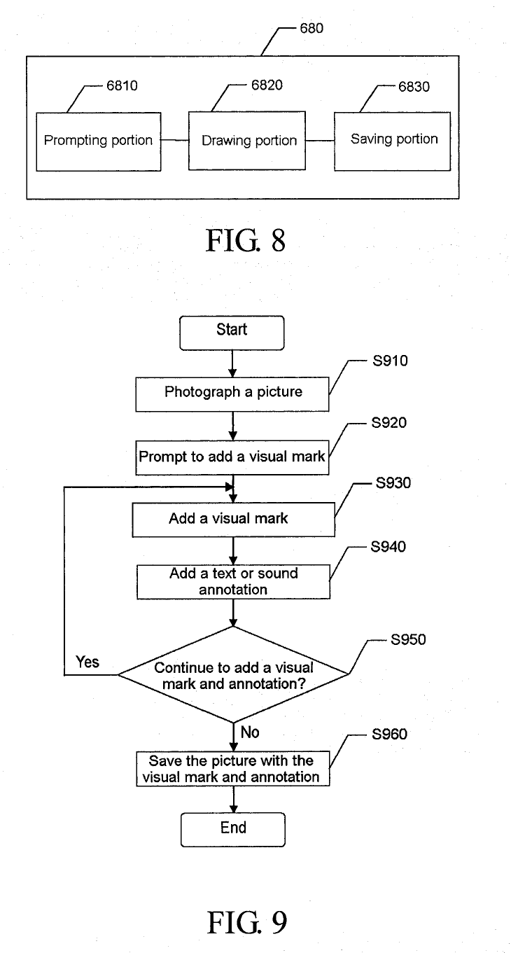

The function and configuration of the visual mark adding device 680 are described as follows with reference to FIG. 8.

As shown in FIG. 8, the visual mark adding device 680 may include a prompting portion 6810, a drawing portion 6820 and a saving portion 6830.

The prompting portion 6810 may be adapted to prompt a user of the mobile phone 600 to add a visual mark onto a picture once the picture is photographed with the camera device 660 included in the mobile phone 600. Preferably, the prompting portion 6810 may be coupled with the camera device 660 so as to be triggered automatically by the completion of the photographing operation. In this case, when a picture is photographed, a prompt such as a text message will be presented to indicate to the user that the mobile phone 600 is changed to a status in which a visual mark may be added onto the photographed picture. Alternatively, the prompting portion 6810 may be provided as a separate button on the mobile phone 600 or a separate menu displayed in the display device 620, which can be pressed or selected by the user to change the mobile phone 600 to a status in which a visual mark may be added onto the photographed picture.

The drawing portion 6820 may be adapted to select, by the user, a position on the photographed picture and draw a visual mark at the position when a prompt is presented by the prompting portion 6810. If the display device 620 includes a touch screen, the drawing portion 6820 may be couple with the touch screen. In this case, the user can select a position on the picture and draw a visual mark at the position by touching the touch screen with one of his/her fingers or a stylus.

The saving portion 6830 may be adapted to save the picture and the added visual mark into the storage device 640 in association with each other.

Although not shown in FIG. 8, an annotation adding portion may optionally be provided in the visual mark adding device 680. The annotation adding portion may be adapted to add a text annotation corresponding to the visual mark, which is typed into the mobile phone 600 via the keypad included in the input device 630. Then, the text annotation may be saved in association with the picture containing the visual mark. Alternatively, the annotation adding portion may be adapted to add a sound annotation corresponding to the visual mark, which is spoken into the mobile phone 600 via the sound recording device 670, for example. The sound annotation may also be saved with the picture containing the visual mark. Preferably, the picture and the text or sound annotation may be saved in a single multi-media file. Alternatively, they may be saved in two separate and linked files.

Then, when viewing the picture added with the visual mark as well as the text or sound annotation, the user may click the visual mark or stay the cursor at the visual mark, so that the mobile phone 600 will present the text or sound annotation paired with the visual mark.

A method for adding a visual mark onto a picture photographed with the camera device 660 included in the mobile phone 600 according to the embodiment of the present disclosure is described as follows with reference to the flow diagram of FIG. 9.

Firstly, in step S910, the user of the mobile phone 600 photographs a picture with the camera device 660 included in the mobile phone 600.

Then, after the photographing operation is completed in step S910, a prompt such as a text message is presented to the user to indicate that a visual mark can be added onto the picture in step S920. Preferably, the prompt may be automatically triggered by the completion of the photographing operation. Alternatively, the automatic prompt may be replace with an operation of pressing a specific button provided on the mobile phone 600 or selecting a menu displayed in the display device 620 by the user. Then, it is possible for the user to add a visual mark onto the picture.

Then, in step S930, the user may select an intended position on the picture to add a visual mark onto the picture. In case that the display device 620 includes a touch screen, the visual mark may be added simply by the user drawing on the touch screen with one of his/her fingers or a stylus. Otherwise, the operation of drawing a visual mark may be performed by operating a specific button such as a navigation key in the keypad included in the input device 630 to move the cursor in the screen of the display device 620.

Then, in step S940, a text or sound annotation may be added to provide a description on the portion covered with the visual mark within the picture after the visual mark is drawn onto the picture in step S930. The text annotation may be typed via the keypad. The sound annotation may be input by the user via the sound recording device 670. This step is optional. That is to say, the step may be removed from the procedure.

Then, in step S950, it is determined whether to continue to further add a visual mark as well as a text or sound annotation onto the picture.

If the determination result in step S950 is “Yes”, then the procedure returns to step S930 to add a new visual mark onto the picture and optionally add a corresponding text or sound annotation.

If the determination result in step S950 is “No”, then the procedure goes to step S960. In this step, the picture may be saved in the storage device 640 of the mobile phone 600 in association with the visual mark and the text or sound annotation. Preferably, the picture, the visual mark and the text or sound annotation may be saved as a single multi-media file. Alternatively, they may be saved separately and linked with each other.

Then, when viewing the picture added with the visual mark as well as the text or sound annotation, the user may click the visual mark or stay the cursor at the visual mark, so that the mobile phone 600 will present the text or sound annotation paired with the visual mark.

An operating circuit or system configuration of the mobile phone 600 is substantially the same as that illustrated in FIG. 5. Thus, a description is not given to the operating circuit of system construction of the mobile phone 600.

It will be appreciated that various portions of the present disclosure can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in the flow diagram or otherwise described herein may be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

The logic and/or steps represented in the flow diagrams or otherwise described herein, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this Specification, a “computer-readable medium” may be any means that can contain, store, communicate, propagate, or transport the program for use by or in combination with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection portion (electronic device) having one or more wires, a portable computer diskette (magnetic device), a random access memory (RAM) (electronic device), a read-only memory (ROM) (electronic device), an erasable programmable read-only memory (EPROM or Flash memory) (electronic device), an optical fiber (optical device), and a portable compact disc read-only memory (CDROM) (optical device). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and drawings depict the various features of the disclosure. It shall be appreciated that the appropriate computer code could be prepared by a person skilled in the art to carry out the various steps and processes described above and illustrated in the drawings. It also shall be appreciated that the various terminals, computers, servers, networks and the like described above may be of any type and that the computer code may be prepared to carry out the disclosure using such apparatus in accordance with the disclosure hereof.

Specific embodiments of the present disclosure are disclosed herein. A person skilled in the art will easily recognize that the disclosure may have other applications in other environments. In fact, many embodiments and implementations are possible. The accompanied claims are in no way intended to limit the scope of the present disclosure to the specific embodiments described above. In addition, any recitation of “means for . . . ” is intended to evoke a means-plus-function reading of an element and a claim, whereas, any elements that do not specifically use the recitation “means for . . . ”, are not intended to be read as means-plus-function elements, even if the claim otherwise comprises the word “means”.

Although the present disclosure has been illustrated and described with respect to a certain preferred embodiment or multiple embodiments, it is obvious that equivalent alterations and modifications will occur to a person skilled in the art upon the reading and understanding of this specification and the accompanied drawings. In particular regard to the various functions performed by the above elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the present disclosure. In addition, although a particular feature of the disclosure may have been described above with respect to only one or more of several illustrated embodiments, such feature may be combined with one or more other features of the other embodiments, as may be desired and advantageous for any given or particular application.

1. A method for adding sound annotations to a picture in a mobile terminal, comprising:
selecting and displaying a picture on a display device of the mobile terminal;
selecting an arbitrary position on the picture;
starting a sound recording function to record sound annotations for said arbitrary position on the picture; and
saving the picture and the recorded sound annotations.

2. The method according to claim 1, wherein the process of saving the picture and the recorded sound annotations comprises saving the picture, the position on the picture where the sound annotations are added, and the corresponding sound annotations in association with each other.

3. The method according to claim 2, wherein the picture and the recorded sound annotations are saved as a single multi-media file.

4. The method according to claim 1, wherein the display device of the mobile terminal has a touch screen, with which a user operates on the displayed picture.

5. The method according to claim 1, wherein the mobile terminal comprises a sound annotation activating key, and the process of adding the sound annotations to the picture is activated by pressing the sound annotation activating key.

6. The method according to claim 1, wherein once a photo is taken with a camera device of the mobile terminal, a sound annotation addition function built in the mobile terminal is immediately activated, so as to start a process of adding sound annotations to the taken photo.

7. The method according to claim 1, wherein when the sound annotations are added to a position on the picture, a sound icon is generated at the position.

8. The method according to claim 7, wherein the sound icon is hidden.

9. A device for adding sound annotations to a picture included in a mobile terminal, comprising:
a sound annotation activating functional portion adapted to activate a process of adding sound annotations to a picture;
a picture selecting portion adapted to select a picture, so as to display the picture on a display device of the mobile terminal;
a sound annotation recording portion adapted to select a position on the picture displayed on the display device of the mobile terminal, and enable a sound recording device of the mobile terminal to record sound annotations for the position; and
a saving portion adapted to save the picture and recorded sound annotations.

10. The device according to claim 9, wherein the saving portion is further adapted to save the picture, the position on the picture where the sound annotations are added, and the corresponding sound annotations in association with each other.

11. The device according to claim 10, wherein the saving portion is further adapted to save the picture and the recorded sound annotations in a single multi-media file.

12. The device according to claim 9, wherein the display device of the mobile terminal has a touch screen, and the picture selecting portion is activated by touching the touch screen.

13. The device according to claim 9, wherein the sound annotation activating functional function is configured as a separate operating button.

14. The device according to claim 9, wherein the sound annotation activating functional function is adapted to couple with a camera device of the mobile terminal, so that once a photo is taken with the camera device, said device for adding sound annotations to a picture is immediately activated to add sound annotations to the taken photo.

15. The device according to claim 9, wherein the sound annotation recording portion is further adapted to generate, when the sound annotations are added to a position on the picture, a sound icon at the position.

16. The device according to claim 15, wherein the sound annotation recording portion is further adapted to hide the sound icon.

17. A mobile terminal, comprising the device for adding sound annotations to a picture according to claim 9.

18. A method for adding a visual mark onto a picture photographed with a camera included in a mobile terminal, comprising:
in response to a picture having been photographed with the camera, prompting a user of the mobile terminal to add a visual mark onto the picture;
selecting, by the user, a position on the picture and drawing a mark at the position; and
saving the picture and the mark in association with each other.

19. The method according to claim 18, wherein the process of prompting is triggered automatically by the completion of the photographing operation.

20. The method according to claim 18, wherein the process of prompting is triggered by the user pressing a specific button provided on the mobile terminal.

21. The method according to claim 18, wherein the mobile terminal comprise a touch screen, and the process of selecting, by the user, a position on the picture and drawing a mark at the position is performed by touching the touch screen with a finger or a stylus.

22. The method according to claim 18, further comprising:
typing or speaking a text or audio annotation into the mobile terminal to pair with the mark; and
saving the text or audio annotation in association with the picture containing the mark.

23. The method according to claim 22, wherein the picture and the text or audio annotation are saved in a single multi-media file.

24. A device for adding a visual mark onto a picture photographed with a camera included in a mobile terminal, comprising:
a prompting portion, adapted to, in response to a picture having been photographed with the camera, prompt a user of the mobile terminal to add a visual mark onto the picture;
a drawing portion, adapted to select, by the user, a position on the picture and draw a mark at the position; and
a saving portion, adapted to save the picture and the mark in association with each other.

25. The device according to claim 24, wherein the prompting portion is coupled with the camera so as to be triggered automatically by the completion of the picture being photographed with the camera.

26. The device according to claim 24, wherein the prompting portion is provided as a specific button on the mobile terminal.

27. The device according to claim 24, wherein the mobile terminal comprise a touch screen, and the drawing portion is coupled with the touch screen so as to select, by the user, a position on the picture and draw a mark at the position by touching the touch screen with a finger or a stylus.

28. The device according to claim 24, further comprising:
an annotation adding portion, adapted to add a text or audio annotation pairing with the mark that is typed or spoken into the mobile terminal,
and wherein the text or audio annotation is saved in association with the picture containing the mark.

29. The device according to claim 28, wherein the picture and the text or audio annotation are saved in a single multi-media file.

30. A mobile terminal, comprising the device according to claim 24.
